(19) United States
(12) Patent Application Publication
(10) Pub. No.: US 2022/0001590 A1
(43) Pub. Date: Jan. 6, 2022

(54) TWIN-SCREW EXTRUDER

(71) Applicant: Mitsubishi Chemical Corporation, Tokyo (JP)

(72) Inventors: Shouhei Okada, Tokyo (JP); Toshihiro Ueda, Tokyo (JP)

(73) Assignee: Mitsubishi Chemical Corporation, Tokyo (JP)

(21) Appl. No.: 17/476,921

(22) Filed: Sep. 16, 2021

Related U.S. Application Data
(63) Continuation of application No. PCT/JP2020/010816, filed on Mar. 12, 2020.

(30) Foreign Application Priority Data
Mar. 20, 2019 (JP) 2019-053136

(51) Int. Cl. B29C 48/76; B29C 48/525; B29C 48/40; B29C 48/29

(52) U.S. Cl. CPC B29C 48/761; B29C 48/525; B29C 48/29; B29C 48/766; B29C 48/40

(57) ABSTRACT

An introduction port 3 is provided on the rear side of a casing 2, and a discharge port 4 is provided at the tip of the casing 2, Inside the casing 2, two screws 7 are arranged so that a center distance thereof gradually decreases from the introduction port 3 to the discharge port 4, In a rear end wall 11, a drainage port 10 that discharges water produced from a material out of the casing 2 is provided. The drainage port 10 is provided at a position higher than the lowermost end of the rear end wall 11.

### TECHNICAL FIELD

The present invention relates to a twin-screw extruder for compression of a water-containing material, and more specifically, to a conical twin-screw extruder and a parallel twin-screw extruder.

### BACKGROUND ART

Conical twin-screw extruders that compress and dewater water-containing materials are disclosed in PTL 1 and PTL 2. Parallel twin-screw extruders that compress and dewater water-containing materials are disclosed in PTL 3 and PTL 4.

In many cases, the materials of the twin-screw extruders are powder materials, pellet materials, or spherical materials, and the materials are viscous. For this reason, the materials clog drainage ports of, for example, existing conical twin-screw extruders and parallel twin-screw extruders, and it is necessary to frequently stop operation or cleaning is needed. In some cases, the materials are discharged through the drainage ports, and there is a possibility that a yield decreases, and that the stability of quality decreases.

### CITATION LIST

### Patent Literature

PTL 1: JP2017-202657A

PTL 2: JP2005-280254A

PTL 3: JP2012-111236A

PTL 4: JP2016-129953A

### SUMMARY OF INVENTION

### Technical Problem

It is an object of the present invention to provide a twin-screw extruder that maintains or improves the efficiency of compressing and discharging water from a water-containing material and that can prevent the material from clogging a drainage port, particularly a conical twin-screw extruder and a parallel twin-screw extruder.

### Solution to Problem

The present inventors have given earnest consideration, found that the problem described above can be solved by taking the following measure to a twin-screw extruder, and completed the present invention based on the finding.

First and second inventions described below relate to a twin-screw extruder, or a conical twin-screw extruder according to a preferable aspect. The present invention, however, is not limited to the conical twin-screw extruder.

A conical twin-screw extruder according to the first invention is a conical twin-screw extruder for compression of a water-containing material including a casing that has a discharge port for a kneaded mixture at a tip and that has an introduction port for the material in a rear portion, and two conical screws that are installed in the casing, wherein the casing has a drainage port, and wherein a lowermost end of the drainage port is higher than a lowermost end in the casing. The drainage port is preferably formed in a rear end wall of the casing or the rear portion of the casing.

According to an aspect of the first invention, no solid-liquid separation means is disposed in the drainage port.

According to an aspect of the first invention, the introduction port is separated from the rear end wall of the casing toward the tip of the casing.

According to an aspect of the first invention, the screws include a seal ring nearer than a rear end of the introduction port to a rear.

A twin-screw extruder according to the second invention is a twin-screw extruder for compression of a water-containing material including a casing that has a discharge port for a kneaded mixture at a tip and that has an introduction port for the material in a rear portion; and two conical screws that are installed in the casing, wherein a flight of each screw includes a chipped portion nearer than a front end of the introduction port to the tip.

According to an aspect of the second invention, the chipped portion chips from an outer edge of the flight toward a screw axis.

According to an aspect of the second invention, a gap between the casing and the flight of each screw becomes narrower in a direction from the introduction port to the discharge port.

A parallel twin-screw extruder according to the third invention is a twin-screw extruder for compression of a water-containing material including a casing that has a discharge port for a kneaded mixture at a tip and that has an introduction port for the material in a rear portion; and two parallel screws that are installed in the casing, wherein no drainage opening is formed between the introduction port and the discharge port.

According to an aspect of the third invention, there is a drainage port in a rear end wall of the casing or between the rear end wall and the introduction port.

### Advantageous Effects of Invention

A twin-screw extruder according to the present invention maintains or improves the efficiency of discharging water from a water-containing material and prevents (or inhibits) the material from clogging a drainage port.

That is, as for the conical twin-screw extruder according to the first invention, the lowermost end of the drainage port is higher than the lowermost end of the casing, and water that is collected in a rearmost portion of the casing overflows through the drainage port and is discharged. Since the lowermost end of the drainage port is higher than the lowermost end in the casing, a part of the material near the lower end of the rearmost portion in the casing is unlikely to reach the drainage port, and the drainage port is prevented from being blocked by the material.

As for the conical twin-screw extruder according to the second invention, the flight has the chipped portion. Accordingly, water that is produced as a result of compression moves toward the rear through the chipped portion, and compressed water is smoothly discharged through the drainage port.

A casing of a parallel twin-screw extruder according to a third invention has no drainage opening between an introduction port to a discharge port, and no blockage of the opening occurs therebetween.

### BRIEF DESCRIPTION OF DRAWINGS

FIG. 1 is a longitudinal sectional view of a conical twin-screw extruder according to an embodiment of a first invention.

FIG. 2a is a horizontal sectional view of the conical twin-screw extruder in FIG. 1.

FIG. 2b is a longitudinal sectional view of a conical twin-screw extruder according to another embodiment of the first invention.

FIG. 2c is a horizontal sectional view of the conical twin-screw extruder in FIG. 2b.

FIG. 3 is a longitudinal sectional view of a conical twin-screw extruder according to another embodiment of the first invention.

FIG. 4 is a longitudinal sectional view of a conical twin-screw extruder according to an embodiment of a second invention.

FIG. 5 is a schematic sectional view taken in a direction perpendicular to the axes of screws of the conical twin-screw extruder in FIG. 4.

FIG. 6 is a schematic sectional view taken in the direction perpendicular to the axes of the screws of the conical twin-screw extruder in FIG. 4.

FIG. 7 is a longitudinal sectional view of a conical twin-screw extruder according to another embodiment of the second invention.

FIG. 8 is a longitudinal sectional view of a parallel twin-screw extruder according to an embodiment of a third invention.

### DESCRIPTION OF EMBODIMENTS

### Embodiment of First Invention

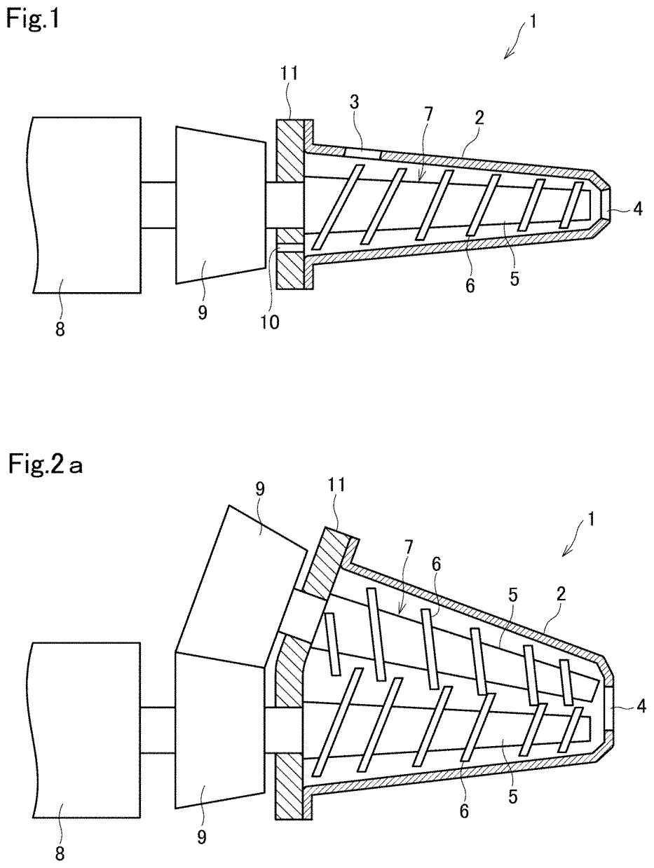

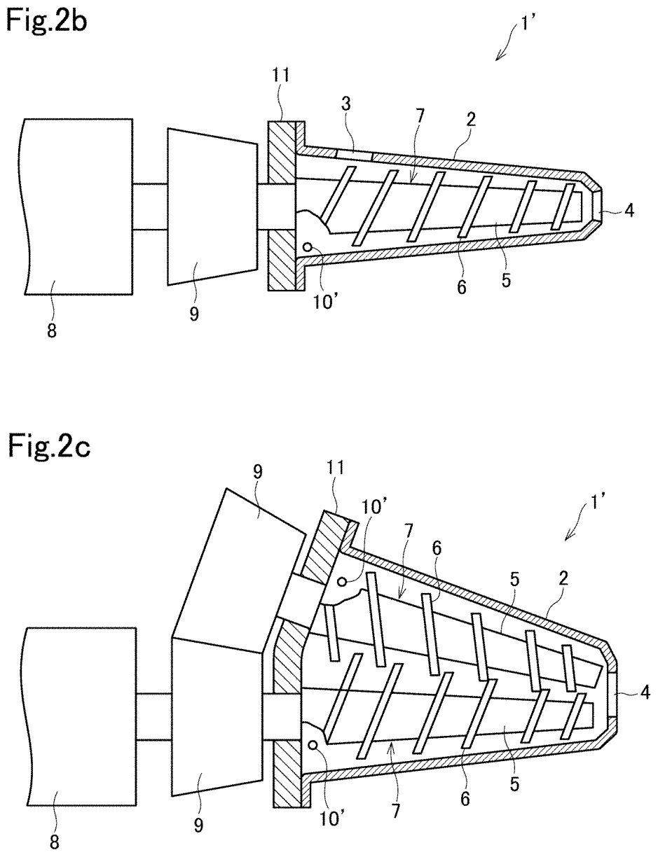

FIG. 1 is a longitudinal sectional view of a conical twin-screw extruder 1 that compresses and dewaters a water-containing material such as water-containing thermoplastic elastomer, rubber, or resin. FIG. 2 is a horizontal sectional view thereof.

The conical twin-screw extruder 1 includes a casing 2. A rear end wall 11 is disposed at the rear end of the casing 2. An upper surface part of a rear portion of the casing 2 has a material introduction port 3 for supplying the water-containing material, and a tip portion thereof has a discharge port 4 for pushing out the dewatered material.

Two screws 7 that convey and compress the water-containing material that is introduced through the introduction port 3 are contained in the casing 2 so as to be adjacent to each other in the horizontal direction. Each screw 7 includes a rotor shaft 5 and a flight 6 that extends from the outer circumference of the rotor shaft 5 and that is spiral.

The two rotor shafts 5 are arranged such that the distance between the shafts gradually decreases in a direction from the introduction port 3 to the discharge port 4. The outer diameter of each rotor shaft 5 and the outer diameter of each flight 6 decrease in the direction from the introduction port 3 to the discharge port 4.

The rotor shafts 5 of the two screws 7 are arranged such that an angle formed between the axes thereof is in the range of 10 to 40 degrees. The two screws 7 are arranged such that the flights 6 engage with each other.

A large-diameter portion of the rotor shaft 5 of each screw 7 is supported by the rear end wall 11 of the casing 2 in a cantilever manner. A driving device 8 is coupled with the rotor shaft 5.

The driving device 8 rotates the two rotor shafts 5 in opposite directions. The rotation directions of the rotor shafts 5 coincide with a direction in which the material that is introduced through the introduction port 3 is put between the two screws 7.

According to the embodiment, one of the rotor shafts 5 is directly driven by the driving device 8, and the other rotor shaft 5 is coupled by bevel gears 9 in an interlocking manner and is driven and rotated in the opposite direction but is not limited to this driving method.

The rear end wall 11 has a drainage port 10 through which water that is produced by compressing the material is discharged from the casing 2 to the outside. The lowermost end of the drainage port 10 is higher than the lowermost end of the rear end wall 11.

The drainage port 10 is an opening that has a size that enables a part of the material to pass therethrough. According to the embodiment, it is not necessary to dispose a solid-liquid separation means such as a screen in the drainage port 10. The distance between the outer circumference of each flight 6 and the inner surface of the casing 2 is preferably less than the diameters of almost all parts of the material. Consequently, the almost all parts of the material are conveyed from the introduction port 3 toward the discharge port 4. Even though the material passes through a gap between the flights 6 and is accumulated on the lower surface of the casing 2 near the drainage port 10, the material is lifted by the rotating flights 6 and moves toward the discharge port. For this reason, the rotational speed of each screw 7 is appropriately maintained depending on the amount of the material that is supplied through the introduction port 3, and the material is consequently inhibited from leaking through the drainage port 10. The reason is that the specific gravity of the material is larger than the specific gravity of water.

The distance between the outer circumference of each flight 6 and the inner surface of the casing 2 is preferably 5 mm or less, more preferably 1 mm or less, further preferably 0.5 mm or less. This prevents the material from moving from the introduction port 3 toward the drainage port 10, and the screws 7 convey the material to the discharge port 4.

As for an existing conical twin-screw extruder, a wedge wire screen, a punching plate, or a reticulated object such as mesh or cloth, for example, is disposed in a drainage port. According to the embodiment, however, such a solid-liquid separation means is preferably not installed.

A lower surface portion of the inner surface of the casing 2 slopes upward in the direction from the rear end wall 11 to the discharge port 4.

In the conical twin-screw extruder that has the structure described above, the water-containing material is introduced through the introduction port 3, is compressed by the screws 7, and is conveyed toward the discharge port 4. The material that is accumulated on the lower surface of the rear portion in the casing 2 is lifted by the flights 6 of the rotating conical screws 7, is transported to the front of the casing 2, and is compressed. The compressed water flows along the slope of the lower surface portion of the casing 2 toward the rear and is discharged through the drainage port 10 in the rear end wall 11. The water that is produced as a result of compression thus flows in the direction opposite the direction of the flow of the material, and this enables dewatering to be efficient.

According to the embodiment, the drainage port 10 is higher than the lowermost end (a position at which the inner surface of the rear end wall 11 intersects a rearmost and lowermost portion of the inner surface of the casing 2) of the rear end wall 11. The lowermost end of the drainage port 10 is higher than the lowermost end of the rear end wall 11. The drainage port 10 is formed such that the lowermost end of the drainage port 10 is higher than the lowermost end of the rear end wall 11 by preferably 5 mm or more, more preferably 10 mm or more, further preferably 15 mm or more and preferably, but not particularly limited to, 200 mm or lass, more preferably 100 mm or less. Consequently, the material is immersed in the compressed water because the specific gravity of the material is larger than that of water (the compressed water), and only the compressed water is selectively discharged through the drainage port. In the case where the drainage port is formed at the lowermost end of the rear end wall 11 of the casing, the material is likely to block the drainage port, and the compressed water is unlikely to be discharged.

When the drainage port 10 is too high, the water level of the compressed water that is collected in the casing 2 reaches the lower edge of the discharge port 4, and the water is discharged through the discharge port 4 together with the material. Accordingly, the level of the lower edge of the opening of the drainage port 10 is preferably lower than the level of the lower edge of the discharge port 4.

A preferable height of the drainage port 10 depends on the size of the casing 2. In the case where the casing 2 is large, the drainage port 10 is preferably high. In the case where the casing 2 is small, or the diameter of the material is small, the drainage port 10 is preferably low.

The conical twin-screw extruder according to the embodiment can be suitably used in the case where a screw diameter (the diameter of a rear end portion) is 100 mm to 500 mm.

According to the embodiment, no solid-liquid separation means is disposed in the drainage port 10, and the drainage port 10 is consequently prevented from being blocked even when the material reaches the drainage port 10.

According to the embodiment, the material introduction port 3 is preferably separated from the rear end wall 11 and located at a position a predetermined distance away therefrom toward the front. Since the introduction port 3 is nearer than the rear end wall 11 to the front, and the drainage port 10 is in the rear end wall 11, the flow of the water that is produced as a result of compression can differ from the flow of the material.

Since the introduction port 3 is separated from the rear end wall 11, the material that is introduced into the casing 2 through the introduction port 3 is prevented from directly reaching the drainage port 10, and the material can be efficiently dewatered.

The distance between the rear end of the introduction port 3 and the rear end wall 11 is preferably 10 mm or more, more preferably 15 mm or more, further preferably 20 mm or more. The upper limit of the length thereof is not particularly limited but is preferably 1000 mm or less in the case where the conical twin-screw extruder has a screw diameter of 200 mm, because it is necessary to ensure regions in which the material is compressed between the screws 7 and the casing 2.

A preferable distance between the rear end of the introduction port 3 and the rear end wall 11 depends on the size of the casing 2. In the case where the casing 2 is large, the distance is preferably long. In the case where the casing 2 is small, the distance is preferably short.

According to an aspect of a first invention, the distance between the rear end of the introduction port 3 and the rear end wall 11 is a distance that enables a screw flight of 360/N° to be between the rear end of the introduction port 3 and the rear end wall 11 for the flights 6 each having N threads. Consequently, the material comes into contact with the screw flight before the material reaches the drainage port and is conveyed to the discharge port 4. The N threads indicate that the number of spirals of the screw flight is N.

According to the embodiment in FIG. 1 and FIG. 2, the drainage port 10 is formed in the rear end wall 11 but may be formed in the casing 2. A conical twin-screw extruder 1′ in this example is illustrated in FIG. 2b and FIG. 2c.

As for the conical twin-screw extruder 1′, drainage ports 10′ are formed in the lower surface parts of the rear portion of the casing 2 at positions slightly higher than the lowermost portion of the casing 2. The distance between the rear edge of each drainage port 10′ on the inner surface of the casing 2 and the inner surface of the rear end wall 11 is 1 mm or more, particularly 3 mm or more, and a position nearer than the rear edge of the introduction port 3 to the rear is preferable. There are no drainage ports beneath the introduction port 3, and this prevents a problem in that the material directly flows into a drainage port when the material is introduced and blocks the drainage port. The material is collected on the lower surface of the casing 2 and moves toward the rear. For this reason, according to the present invention, no drainage ports are formed in the lower surface of the casing 2 although this is not at the lowermost end of the casing 2.

Also, according to the embodiment, the drainage ports 10 are formed such that the lowermost ends (the lowermost ends of the drainage ports 10′ on the inner surface of the casing 2) of the drainage ports 10 are higher than the lowermost end (the position at which the inner surface of the rear end wall 11 intersects the rearmost and lowermost portion of the inner surface of the casing 2) of the rear end wall 11 by preferably 5 mm or more, more preferably 10 mm or more, further preferably 15 mm or more and preferably, but not particularly limited to, 200 mm or lass, more preferably 100 mm or less. Consequently, the material is immersed in the compressed water because the specific gravity of the material is larger than that of water (the compressed water), and only the compressed water is selectively discharged through the drainage ports.

The other structure of the conical twin-screw extruder 1′ is the same as that of the conical twin-screw extruder 1. The other reference characters in FIG. 2b and FIG. 2c designate components like to those in FIG. 1 and FIG. 2a.

FIG. 2b is a longitudinal sectional view of the same portion as in FIG. 1. FIG. 2c is a horizontal sectional view of the same portion as in FIG. 2a. In FIG. 2b and FIG. 2c, the screws 6, 7 are illustrated with parts near base ends removed to make the drainage ports 10′ clear. However, the screws 6, 7 do not actually have such notches. The actual shapes of the screws 6, 7 are the same as those of the screws 6, 7 in FIG. 1 and FIG. 2a.

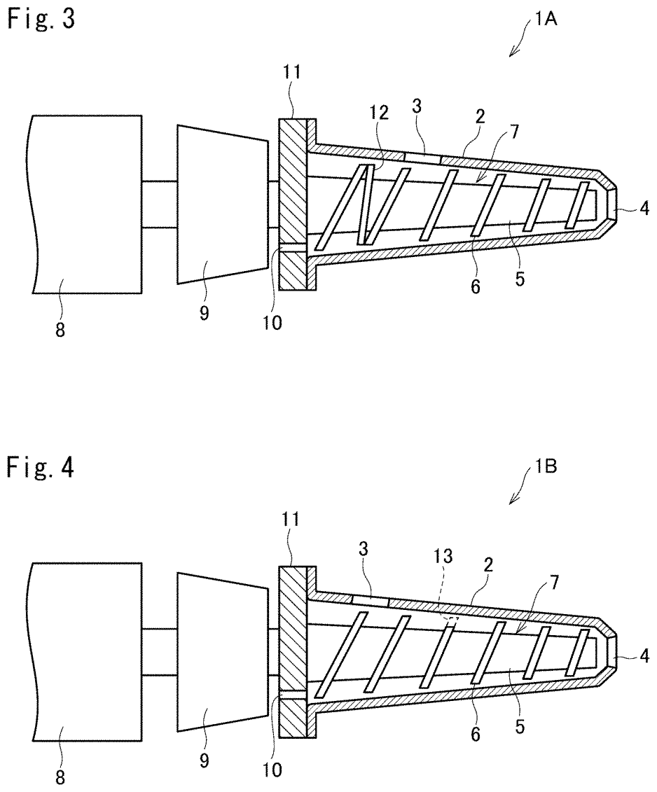

FIG. 3 is a longitudinal sectional view of a conical twin-screw extruder 1A according to another embodiment of the first invention.

According to the embodiment, each screw 7 includes a seal ring 12 between the rear end of the introduction port 3 and the rear end wall 11. The other structure of the conical twin-screw extruder 1A in FIG. 3 is the same as that of the conical twin-screw extruder 1 described above, and like reference characters designate like components.

In the conical twin-screw extruder 1A, the material that is introduced does not reach the drainage port 10 but is conveyed by the screws 7 to the discharge port 4, and the material can be efficiently dewatered.

Each seal ring 12 closes a plane obtained by virtually cutting the interior space of the casing 2 along a section angled at 45° to 135° with respect to the axis of the screw 7 or the lower surface of the casing 2. The seal ring 12 preferably closes a plane obtained by virtually cutting the interior space along a section perpendicular to the axis of the screw 7.

The distance between the outer circumference of each seal ring 12 and the inner surface of the casing 2 is preferably 10 mm or less, more preferably 5 mm or less, further preferably 1 mm or less, particularly preferably 0.5 mm or less. This prevents the material from moving to a position nearer than the seal rings 12 to the rear, and the material is conveyed by the screws 7 to the discharge port 4.

A preferable range of the distance between the outer circumference of each seal ring 12 and the inner surface of the casing 2 depends on the size of the conical twin-screw extruder 1A. In the case where the conical twin-screw extruder 1A is large, or the diameter of the material is large, the distance is preferably long. In the case where the conical twin-screw extruder 1A is small, or the diameter of the material is small, the distance is preferably short. According to the embodiment, the conical twin-screw extruder 1A preferably has a screw diameter of 100 mm to 500 mm.

### Reference Example 1

A test was conducted by using a conical twin-screw extruder, CF-1V, of EM ENGINEERING CO., LTD. The screw diameter of the CF-1V was 160 mm.

A gap having a width of 9 mm was formed at the lowermost end of the rear end wall of the conical twin-screw extruder and was used as a drainage port for a dewatering test. The test was conducted under conditions of a discharge amount of 25 kg/h to 90 kg/h and a rotational speed of 15 rpm to 45 rpm. A material that was used was a rubber composition having a water content of 30%. The main components of the rubber composition were emulsion polymerization SBR (styrene-butadiene rubber) and carbon black. The material had a spherical shape the diameter of which was 1 mm to 50 mm, and the specific gravity thereof was about 1.1.

The result of the test was that the water content reached about 4% under conditions in which the water content decreased the most. However, the material blocked the drainage port several times during the test, the material that clogged the drainage port needed to be manually removed, and a blockage needed to be released.

A test was conducted on a different material by using the same equipment and under the same conditions. The material that was used was a rubber composition having a water content of 50% or more. The main components of the rubber composition were natural rubber and carbon black, and the rubber composition contained other components such as any one kind of silica, carbon nanotube, carbon nanofiber, graphene, cellulose, and cellulose nanofiber, or some kinds of these. The material had a spherical shape the diameter of which was 0.5 mm or less. A rubber composition having a small particle diameter typically has a high water content, is unlikely to be compressed, and is difficult to dewater. The result of the test was that the rubber composition that was the material blocked the drainage port, was not compressed, and was not dewatered.

### Embodiment of Second Invention

According to a second invention, the flight 6 of each screw 7 includes a chipped portion 13 as illustrated in a conical twin-screw extruder 1B in FIG. 4. The chipped portion corresponds to a hole or a notch portion of the screw flight, or a combination thereof. The other structure of the conical twin-screw extruder 1B in FIG. 4 is the same as that of the conical twin-screw extruder 1 in FIG. 1 and FIG. 2, and like reference characters designate like components.

In the conical twin-screw extruder 1B, the material can be more uniformly dewatered than the case of the screw flight that does not include the chipped portion. That is, when the material moves from the introduction port 3 to the discharge port 4, a part of the material passes through a position near the rotor shaft 5, and a part of the material passes through a position that is far from the rotor shaft 5 and that is near the inner surface of the casing 2. As for the part of the material that passes through the position near the rotor shaft 5, the water that is produced as a result of compression has nowhere to go and is unlikely to be discharged. As for the part of material that passes through the position near the inner surface of the casing 2, the part readily passes through gaps between the lower surface of the casing 2 and the flights 6, and the water is guided to the drainage port 10 and is likely to be discharged. Since each flight 6 includes the chipped portion such as a hole or a notch, the water that is produced by dewatering the part of the material that passes through the position near the rotor shaft 5 can be effectively guided to the drainage port.

The material itself can pass through the chipped portion 13 such as a hole or a notch. In this case, a residence time during which the material enters through the introduction port 3 and exits through the discharge port 4 increases, a time during which the material is compressed increases, and the efficiency of discharging the water from the material improves.

In the case where the chipped portion 13 includes a hole, the diameter of the hole is preferably more than 0.5 mm and less than 30 mm, and the position of the hole is preferably near the rotor shaft 5.

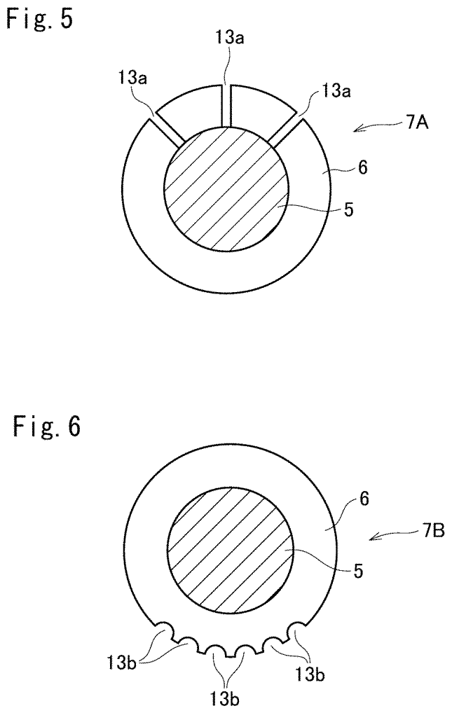

In the case where the chipped portion 13 includes notches 13a or 13b as illustrated in FIG. 5 and FIG. 6, the depths of the notches are preferably more than 0.1 mm, and the widths of the notches are preferably more than 0.1 mm and less than 30 mm. There is no upper limit of the depths of the notches. As illustrated in FIG. 5, the notches 13a may be deep so as to extend to the rotor shaft 5.

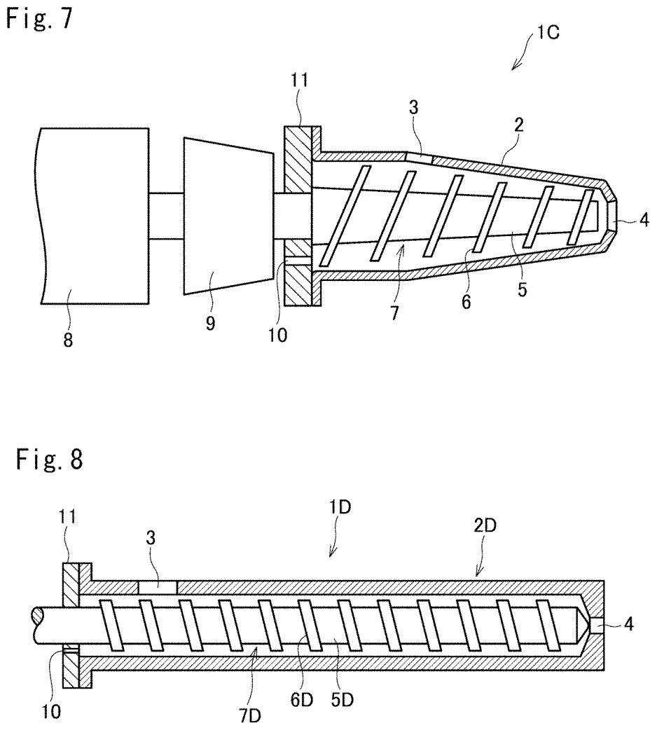

According to an aspect of the second invention, the gaps between the casing 2 and the flights 6 near the discharge port 4 are narrower than those near the introduction port 3 as illustrated in a conical twin-screw extruder 1C in FIG. 7. According to the embodiment, the gaps become narrower in the direction from the introduction port 3 to the discharge port 4. The other structure in FIG. 7 is the same as that in FIG. 4, and like reference characters designate like components.

The embodiment is particularly effective for the case where the screw flight includes the chipped portion 13 such as a hole or a notch, and the material is successfully dewatered particularly in regions near the screw axes. In particular, a large conical twin-screw extruder that has a high processing capacity has a remarkable dewatering effect, and a combination with the screw flight that is partly chipped is very effective for efficient dewatering. That is, the material is successfully caught on the flights 6, and the material can be compressed and dewatered at high pressure.

As for the conical twin-screw extruder 1C, A/B is preferably 1.01 or more, more preferably 1.05 or more where A is the distance from the inner surface of the casing 2 to the tip (the outer circumference end) of each flight 6 along a plane that is perpendicular to each screw axis and that passes through the position of the front end of the introduction port 3, and B is the distance from the inner surface of the casing 2 to the tip of the flight 6 along a plane that is perpendicular to the screw axis and that passes through the position of the tip of the screw 7. In the case where the gaps between the casing 2 and the flights 6 are too large, the degree of compression of the material decreases, and the efficiency of dewatering decreases. Accordingly, A/B is preferably 1.5 or less.

### Reference Example 2

A test was conducted by using the conical twin-screw extruder, CF-1V, of EM ENGINEERING CO., LTD. The screw diameter of the CF-1V was 160 mm. Each screw thereof included no chipped portion. A gap between the screw and a casing was constant between an introduction port and a discharge port.

A gap having a width of 9 mm was formed at the lowermost end of the rear end wall of the conical twin-screw extruder and was used as the drainage port for a dewatering test. The test was conducted under conditions of a discharge amount of 25 kg/h to 90 kg/h and a rotational speed of 15 rpm to 45 rpm. A material that was used was a rubber composition having a water content of 30%. The main components of the rubber composition were emulsion polymerization SBR (styrene-butadiene rubber) and carbon black. The material had a spherical shape the diameter of which was 1 mm to 50 mm, and the specific gravity thereof was about 1.1.

As for parts of the material that remained and adhered to each screw, the water contents of parts of the material near the screw axes and parts of the material far from the screw axes were compared after the test. It was consequently recognized that the parts of the material near the screws had a water content higher than those of the others.

A test was conducted on a different material by using the same equipment and under the same conditions. The material that was used was a rubber composition having a water content of 50% or more. The main components of the rubber composition were natural rubber and carbon black, and the rubber composition contained other components such as any one kind of silica, carbon nanotube, carbon nanofiber, graphene, cellulose, and cellulose nanofiber, or some kinds of these. The material had a spherical shape the diameter of which was 0.5 mm or less. A rubber composition having a small particle diameter typically has a high water content, is unlikely to be compressed, and is difficult to dewater. The result of the test was that the rubber composition that was the material blocked the drainage port, was not compressed, and was not dewatered.

### Embodiment of Third Invention

FIG. 8 is a longitudinal sectional view of a parallel twin-screw extruder 1D according to an embodiment of a third invention.

According to the embodiment, two parallel screws 7D are contained in a casing 2D. The height and width of the interior of the casing 2D are constant over the entire length of the casing 2D. The diameters of rotor shafts 5D are constant overall in the longitudinal direction of the screws 7D. The diameters of flights 6D are also constant. However, the diameters of the flights 6D may gradually increase in the direction toward the discharge port 4 as described later. The other structure of the conical twin-screw extruder 1D is the same as that of the conical twin-screw extruder 1 in FIG. 1 and FIG. 2, and like reference characters designate like components.

In the parallel twin-screw extruder 1D, no drainage opening is formed between the introduction port 3 and the discharge port 4. A drainage opening is classified into a dewatering port and a drainage port. The dewatering port and the drainage port correspond to openings through which water is discharged from the casing 2. However, the water is discharged through the dewatering port from an apparatus to the outside at substantially the same time the water-containing material is compressed. For this reason, the water that is produced as a result of compression and the material that is compressed or that is not compressed pass through a position at which the water and the material come into contact with the dewatering port. In some cases where the material comes into contact with the dewatering port, the material leaks through the dewatering port and blocks the dewatering port. The drainage port corresponds to the opening for discharging the water from the casing 2 to the outside. The material does not pass through a position at which the material comes into contact with the drainage port.

The purposes of an existing parallel twin-screw extruder include dewatering, and a dewatering port is typically formed between a material introduction port and a discharge port. A solid-liquid separation means such as a slit, mesh, or perforated metal is installed in the dewatering port in order to prevent a material from leaking through the dewatering port. However, when the material is filled in the parallel twin-screw extruder, and pressure increases, the material leaks through the dewatering port even with the solid-liquid separation means installed. It is very difficult to prevent the material that has liquidity from moving from a high-pressure location to a low-pressure location by merely contriving the structure of the slit, the mesh, or the perforated metal or the shapes of the screws.

In the parallel twin-screw extruder according to the third invention, no drainage opening is formed in a region in which there is the material, that is, between the introduction port 3 and the discharge port 4, and the material is consequently prevented from leaking. The material is transported by the screws 7D from the introduction port 3 to the discharge port 4, during which the pressure increases, and the material is compressed. The water as a result of compression has viscosity that is much lower than that of the material and readily moves in a direction in which the pressure decreases, that is, in the direction from the discharge port 4 to the introduction port 3.

According to the third invention, the drainage port 10 is preferably formed in the rear end wall 11 of the parallel twin-screw extruder 1D or in the lower surface of the casing 2D between the rear end wall 11 and the introduction port 3. This prevents the material from leaking through the drainage port 10 and enables the water to be efficiently discharged.

According to the third invention, the drainage port 10 is formed preferably in the lowermost portion of the rear end wall 11 in the vertical direction or at a position higher than the lowermost portion, more preferably at a position higher than the lowermost portion and 30 mm or less away from the lowermost portion.

A solid-liquid separation means such as a wedge wire screen, a punching plate, or a reticulated object such as mesh or cloth that is disposed in the dewatering port of the existing parallel twin-screw extruder is not disposed in the drainage port of the parallel twin-screw extruder according to the third invention.

According to the third invention, the distance between the tip of each flight 6D and the inner surface of the casing 2D may decrease in the direction from the introduction port 3 to the discharge port 4 in a manner in which the diameter of the flight 6D is increased in the direction toward the discharge port 4 between the introduction port 3 and the discharge port 4 of the parallel twin-screw extruder 1D. Consequently, the water that is produced from the material as a result of compression efficiently flows toward the rear, and the water that is produced as a result of compression is efficiently discharged through the drainage port 10.

According to the third invention, an evacuation vent may be installed in the lowermost surface of the casing 2 between the introduction port 3 and the discharge port 4 of the parallel twin-screw extruder 1D. Evacuation through the evacuation vent enables the water content of an extrusion object to be further decreased.

The water that is produced from the material as a result of compression moves downward in the casing 2 due to the effect of gravity. Accordingly, the lower the position of a kneaded mixture in the casing 2, the larger the amount of the water that is contained. For this reason, the water is efficiently discharged by evacuation from the lowermost surface of the casing 2 unlike evacuation from the uppermost surface of the casing 2.

A mass of a sufficiently kneaded mixture is transported from the introduction port 3 to the discharge port 4. An impurity component that is unlikely to be integrated with the kneaded mixture, for example, resin that is fired and that changes in quality or a foreign substance moves downward due to the gravity and is likely to be discharged through the evacuation vent in the lowermost surface.

In the case where the solid-liquid separation means such as a slit, mesh, or perforated metal is disposed in the evacuation vent, there is a possibility that the material is accumulated and becomes a blockage. Accordingly, the solid-liquid separation means is preferably not disposed therein. During typical operation under conditions in which venting up does not occur in an evacuation vent at the uppermost end of the parallel twin-screw extruder in the vertical direction, the material does not leak through the evacuation vent from the lowermost surface.

In many cases, the parallel twin-screw extruder is installed such that the direction of each screw axis is horizontal. However, the parallel twin-screw extruder may be installed such that the direction of the screw axis is inclined. In the case where the direction of the screw axis is inclined, the parallel twin-screw extruder is preferably installed such that the rear end wall is lower than the discharge port. Consequently, the water that is produced from the material as a result of compression is likely to flow toward the drainage port along the inclination of the casing.

The water content of the extrusion object is preferably 5 weight % or less, more preferably 1 weight % or less, further preferably 0.1 weight % or less although this depends on requested performance.

In the case where the rubber composition is dewatered by using the existing parallel twin-screw extruder, and the water content of the rubber composition is more than 50%, dewatering is very difficult. However, the use of the parallel twin-screw extruder according to the third invention achieves sufficient dewatering and enables the water content to be decreased to 1% or less even when the water content of the rubber composition is more than 50%. (How this is achieved merely by parallel twin-screws)

In the case where the rubber composition is dewatered by using the existing parallel twin-screw extruder, and the water content of the rubber composition is 10 to 50%, the water content does not decrease to 1% although the rubber composition is dewatered. For this reason, in the case where it is necessary to dewater the rubber composition up to a water content of 1% or less, drying with, for example, a dryer is needed. However, drying with the dryer needs a large amount of energy and time and results in high costs. The use of the parallel twin-screw extruder according to the third invention achieves sufficient dewatering and enables the water content to be decreased to 1% or less even when the water content of the rubber composition is 10 to 50%.

### [Material]

The material that is used for the present invention is not particularly limited provided that the material is a water-containing material to be compressed and dewatered, and examples thereof include rubber components such as thermoplastic elastomer and rubber and a water-containing material such as resin. The rubber components are preferably used. Examples of the rubber components are not particularly limited and include solution polymerization SBR (styrene-butadiene rubber), emulsion polymerization SBR, and natural rubber. The water-containing material is not limited to a rubber component alone, and a rubber component, carbon black, an anti-ageing agent, oils and fats, and a composition of other components are preferably used. The other components include, but not particularly limited to, carbon nanotube, carbon nanofiber, graphene, cellulose, and cellulose nanofiber. The specific gravity of the material is preferably more than 1.0, more preferably 1.05 or more, further preferably 1.1 or more. The reason is that the material is readily separated from water (the compressed water). The size of the water-containing material is not particularly limited, but the water-containing material typically has a spherical shape having a diameter of 1 to 50 mm.

For equipment for continuously molding the dewatered material, a tubular mouthpiece is preferably disposed in the discharge port of the parallel twin-screw extruder, and a cutter blade is preferably mounted on a part of the mouthpiece. Consequently, the material that exits through the discharge port is molded into a sheet shape.

### <Combination of First to Third Inventions>

The first, second, and third inventions can be freely combined. A series of dewatering and kneading processes are obtained by combining these.

In the case where the series of dewatering and kneading processes are used, not only materials having different shapes, different degrees of viscosity, and different degrees of liquidity can be continuously dewatered, but also there is no dewatering port, and the drainage port is unlikely to be blocked. This results in advantages: an improvement in yield, a decrease in the number times the operation is stopped, and a decrease in the number of times cleaning is performed.

For example, a conical twin-screw dewaterer according to the present invention and a parallel twin-screw dewaterer according to the present invention are combined in series, and a material water content of 60 to 70% can be consequently decreased to a water content of 20 to 30% by using the conical twin-screw dewaterer and decreased to a water content of 5% or less by using the parallel twin-screw dewaterer. The same combination enables a material water content of 30 to 50% to be decreased to a water content of 5 to 10% by using the conical twin-screw dewaterer and to be decreased to a water content of 1% or less by using the parallel twin-screw dewaterer.

### EXAMPLES

### Example 1

A test was conducted by using a parallel twin-screw extruder, TEX44α, of The Japan Steel Works, Ltd. The parallel twin-screw extruder had a drainage port in a rear end wall and had no dewatering port between a material introduction port and a discharge port. The test was conducted under conditions of a discharge amount of 15 kg/h to 70 kg/h and a rotational speed of 30 rpm to 80 rpm. A material that was used was a rubber composition having a water content of 30%. The main components of the rubber composition were emulsion polymerization SBR (styrene-butadiene rubber) and carbon black. The material had a spherical shape the diameter of which was 1 mm to 50 mm, and the specific gravity thereof was about 1.1.

The result of the test was that the rubber composition that was the material was not found in the drainage port under any conditions. The water content reached 0.57% under conditions in which the water content decreased the most.

A test was conducted on a different material by using the same equipment and under the same conditions. The material that was used was a rubber composition having a water content of 50% or more. The main components of the rubber composition were natural rubber and carbon black, and the rubber composition contained other components such as any one kind of silica, carbon nanotube, carbon nanofiber, graphene, cellulose, and cellulose nanofiber, or some kinds of these. The material had a spherical shape the diameter of which was 0.5 mm or less. A rubber composition having a small particle diameter typically has a high water content, is unlikely to be compressed, and is difficult to dewater.

However, the result of the test was that the rubber composition that was the material was dewatered and was not found in the drainage port. Fine rubber composition particles were discharged through the drainage port together with the compressed water. The fine rubber composition particles that were discharged were readily separated from the water and were collected. Since there were no solid-liquid separation means in the drainage port, there was no blockage in the equipment. The material was readily collected, and it was understood from this that the frequency of maintenance can be low, and continuous operation time can be kept long for continuous operation with the equipment. Although there was no solid-liquid separation means in the drainage port, the amount of the material that was discharged through the drainage port was very small, and the collected material was able to be introduced again in the equipment.

### Example 2

A conical feeder, CF-2V, of EM ENGINEERING CO., LTD., was modified and was used as a conical twin-screw dewaterer to conduct a test. The CF-2V was a large model of the CF-1V described above and had the same basic structure and a screw diameter of 200 mm. The CF-2V had no openings through which the material and moisture are discharged except for a discharge port, and an introduction port was not separated from a rear end wall toward the tip of a casing before being modified, as in a typical conical feeder. The conical feeder had no seal ring. The CF-2V was modified, and a drainage port was formed such that the lowermost end of the drainage port was higher than the lowermost end in the casing. The introduction port was separated from the rear end wall toward the tip of the casing. A seal ring was provided.

The test was conducted under conditions of a discharge amount of 3 kg/h to 100 kg/h and a rotational speed of 5 rpm to 30 rpm. A material that was used was a rubber composition having a water content of 30%. The main components of the rubber composition were emulsion polymerization SBR (styrene-butadiene rubber) and carbon black. The material had a spherical shape the diameter of which was 1 mm to 50 mm, and the specific gravity thereof was about 1.1. The result of the test was that the rubber composition that was the material was not found in the drainage port under any conditions. The drainage port was not blocked during six hours of the test. The water content reached 4.1% under conditions in which the water content decreased the most.

A test was conducted on a different material by using the same equipment and under the same conditions. The material that was used was a rubber composition having a water content of 65% or more. The main components of the rubber composition were natural rubber and carbon black, and the rubber composition contained other components such as any one kind of silica, carbon nanotube, carbon nanofiber, graphene, cellulose, and cellulose nanofiber, or some kinds of these. The material had a spherical shape the diameter of which was 0.5 mm or less. A rubber composition having a small particle diameter typically has a high water content, is unlikely to be compressed, and is difficult to dewater. However, the result of the test was that the rubber composition that was the material was dewatered up to 24.5% under conditions in which the material was dewatered the most. The rubber composition that was the material was not found in the drainage port.

### Comparative Example (Comparative Example Against Example 2)

The apparatus was such that the seal ring and the drainage port described in the example 2 were installable and removable, and the original states thereof were restorable. The apparatus was such that the original position of the separated introduction port described in the example 2 was restorable. For this reason, whether each effect was exerted in each single state was also checked.

A test was first conducted by using the same material under the same conditions as in the example 2 with the drainage port formed at the lowermost end in the casing, with no seal ring provided, and with the introduction port being not separated from the rear end wall. The result was that the drainage port at the lowermost end in the casing was blocked by the material at several minutes after the start of the test, water that was produced as a result of compression had nowhere to go, and the effect of dewatering was not achieved.

A test was conducted by using the same material under the same conditions as in the example 2 with the drainage port formed such that the lowermost end of the drainage port was higher than the lowermost end in the casing, with no seal ring provided, and with the introduction port being not separated from the rear end wall. The result was that the drainage port was blocked at several minutes of the test, and the effect of dewatering was not achieved. The reason was that a large amount of the material was located behind at a certain moment before the material that was introduced was conveyed by the screws to the front, and the material that was located behind in this state blocked the drainage port when lifted by the screws.

Subsequently, a test was conducted by using the same material under the same conditions as in the example 2 with the drainage port formed such that the lowermost end of the drainage port was higher than the lowermost end in the casing, with a seal ring provided, and with the introduction port being not separated from the rear end wall. The result was that the drainage port was blocked at several minutes of the test, and the effect of dewatering was not achieved. The entire material did not enter a location nearer than the seal ring to the front when introduced with the introduction port being not separated from the rear end wall even in the case where the seal ring was provided, a part thereof entered a location nearer than the seal ring to the rear, and the material blocked the drainage port when lifted by the screws.

Subsequently, a test was conducted by using the same material under the same conditions as in the example 2 with the drainage port formed at the lowermost end in the casing, with the seal ring provided, and with the introduction port separated from the rear end wall. The result was that the drainage port was blocked at several minutes of the test, and the effect of dewatering was not achieved. In the case where the drainage port was located at the lowermost end in the casing, and a small amount of the material was conveyed toward the rear, the material entered the drainage port and gradually blocked the drainage port, even with the seal ring provided and with the introduction port separated from the rear end wall.

The present invention is described in detail by using specific aspects. However, it is clear for a person in the skill that various modifications can be made without departing from the intention and scope of the present invention.

### INDUSTRIAL APPLICABILITY

The present invention can be used for a manufacturing apparatus and a processing apparatus composed of thermoplastic elastomer, rubber, or resin.

The present invention application is based on Japanese Patent Application No. 2019-053136 filed in the Japan Patent Office on Mar. 20, 2019, the entire contents of which are incorporated herein by reference.

1. A conical twin-screw extruder for compression of a water-containing material, comprising:
a casing that has a discharge port for a kneaded mixture at a tip and that has an introduction port for the material in a rear portion; and
two screws that are installed in the casing,
wherein the casing has a drainage port, and
wherein a lowermost end of the drainage port is higher than a lowermost end in the casing.

2. The conical twin-screw extruder according to claim 1, wherein the drainage port is formed in a rear end wall that is disposed at a rear end of the casing.

3. The conical twin-screw extruder according to claim 2, wherein the lowermost end of the drainage port is 5 to 200 mm higher than a position at which an inner surface of the rear end wall intersects a rearmost and lowermost portion of an inner surface of the casing.

4. The conical twin-screw extruder according to claim 1, wherein the drainage port is formed in a lower surface part of the rear portion of the casing.

5. The conical twin-screw extruder according to claim 4, wherein a rear end wall is disposed at a rear end of the casing, and
wherein a distance between a rear edge of the drainage port on an inner surface of the casing and an inner surface of the rear end wall is 1 mm or more, and the rear edge of the drainage port is nearer than a rear edge of the introduction port to a rear.

6. The conical twin-screw extruder according to claim 4, wherein a rear edge of the drainage port on an inner surface of the casing is 5 to 200 mm higher than a position at which an inner surface of the rear end wall intersects a rearmost and lowermost portion of an inner surface of the casing.

7. The twin-screw extruder according to claim 1, wherein no solid-liquid separation means is disposed in the drainage port.

8. The twin-screw extruder according to claim 1, wherein the introduction port is separated from the rear end wall of the casing toward the tip of the casing.

9. The twin-screw extruder according to claim 1, wherein the screws include a seal ring nearer than a rear end of the introduction port to a rear.

10. A twin-screw extruder for compression of a water-containing material, comprising:
a casing that has a discharge port for a kneaded mixture at a tip and that has an introduction port for the material in a rear portion; and
two conical screws that are installed in the casing,
wherein a flight of each screw includes a chipped portion nearer than a front end of the introduction port to the tip.

11. The twin-screw extruder according to claim 5, wherein the chipped portion chips from an outer edge of the flight toward a screw axis.

12. The twin-screw extruder according to claim 10, wherein a gap between the casing and the flight of each screw becomes narrower in a direction from the introduction port to the discharge port.

13. A parallel twin-screw extruder for compression of a water-containing material, comprising:
a casing that has a discharge port for a kneaded mixture at a tip and that has an introduction port for the material in a rear portion; and
two parallel screws that are installed in the casing,
wherein no drainage opening is formed between the introduction port and the discharge port.

14. The parallel twin-screw extruder according to claim 13, wherein there is a drainage port in a rear end wall of the casing or between the rear end wall and the introduction port.

15. A method of compressing and dewatering a rubber composition by using the twin-screw extruder according to claim 1.
